(19) United States
(12) Patent Application Publication
(10) Pub. No.: US 2026/0357606 A1
(43) Pub. Date: Nov. 12, 2026

(54) CLEANROOM FACILITY

(71) Applicant: CYTIVA SWEDEN AB, Uppsala (SE)

(72) Inventors: Chinmay Bhogaonkar, Umeå (SE); Marian Dembkiewicz, Umeå (SE); Laurenz Simonis, Umeå (SE)

(21) Appl. No.: 19/485,363

(22) PCT Filed: May 21, 2024
(86) PCT No.: PCT/EP2024/063921

§ 371 Date: Nov. 18, 2025

(30) Foreign Application Priority Data
May 23, 2023 (SE) 2350620-7

(51) Int. Cl. E04H 5/02; B01L 1/04; E04H 1/00

(52) U.S. Cl. CPC E04H 5/02; B01L 1/04; E04H 1/005

(57) ABSTRACT

A cleanroom facility (10) is disclosed, comprising a processing area (110) for processing of biopharmaceutical products, a service area (120) for supply of processing material (20) to the processing area (110), the service area (120) being separated from the processing area (110) by a wall (130), and a pass-through (300) arranged in the wall (130), wherein the pass-through (300) is configured to allow the material (20) to be supplied to the processing area (110). The pass-through (300) comprises a latch (310) facing the processing area (110) and a docking port (320) facing the service area (120). Further, the docking port (320) is configured to allow a sealed container (400), comprising the material (20), to be docked to the pass-through (300) and accessed through the latch (310).

### TECHNICAL FIELD

The present disclosure relates to manufacturing of biopharmaceutical products, and more specifically to a cleanroom facilities and technologies for such manufacturing.

### BACKGROUND

With the ever-increasing development of novel biopharmaceutical products, there is a corresponding need to build specialised cleanroom facilities to accommodate manufacturing of such biopharmaceutical products. Biopharmaceutical manufacturing puts high demand on biosafety and cleanliness to prevent loss of biological integrity, for example through release of harmful chemicals to the environment, as well as product contamination by particulate matter and microorganisms. Biopharmaceutical manufacturing therefore requires relatively complex and expensive cleanroom facilities.

Entities in the business of developing and manufacturing biopharmaceutical products typically have permanent cleanroom facilities which are designed to provide appropriate levels of cleanroom technology, and which are validated to ensure compliance with applicable standards. Strict standards and regulations may however be prohibitive in both time and cost and risk making it challenging to modify and expand the cleanroom facilities to meet changing demands. Entities that do not routinely develop or manufacture biopharmaceutical products, and therefore do not have appropriate dedicated cleanroom facilities, experience similar challenges with designing, building, and validating new facilities.

A need therefore exists for improved cleanroom facilities, which are more flexible, efficient, and scalable without compromising on cleanliness.

### SUMMARY

An object of the present disclosure is to provide solutions which seek to address one or more of the above-identified deficiencies in the art.

According to a first aspect, a cleanroom facility for manufacturing of biopharmaceutical products is provided. The cleanroom facility comprises a processing area for processing of the biopharmaceutical products, a service area for supply of material for the processing of the biopharmaceutical products to the processing area, the service area being separated from the processing area by a wall, and a pass-through arranged in the wall. The pass-through is configured to allow the material to be supplied to the processing area. The pass-through comprises a latch facing the processing area and a docking port facing the service area. The docking port is configured to allow a sealed container, comprising the material, to be docked to the pass-through and accessed through the latch.

According to a second aspect, a pass-through for a cleanroom facility for manufacturing of biopharmaceutical products is provided. The pass-through is configured to be arranged in a wall separating a processing area for processing of the biopharmaceutical products and a service area and to allow material for the processing of the biopharmaceutical products to be supplied from the service area to the processing area. The pass-through comprises a docking port configured to be arranged to face the service area and allow a sealed container to be docked to the pass-through. Further, the pass-through comprises a latch configured to be arranged to face the processing area and allow the material in the docked container to be accessed from the processing area.

According to a third aspect, a sealed container for supply of material for processing of biopharmaceutical products in a cleanroom facility is provided. The container comprises a body configured to accommodate the material, a sealing for maintaining a predetermined grade of cleanliness of the material, and a docking interface configured to be docked to a docking port of a pass-through. The pass-through is arranged in a wall, separating a processing area for processing of the biopharmaceutical products and a service area, such that the docking port faces the service area. Further, the pass-through comprises a latch facing the processing area and being configured to allow the material in the docked container to be accessed from the processing area.

According to a fourth aspect, a cleanroom facility for manufacturing of biopharmaceutical products is provided. The cleanroom facility comprises a processing area comprising a first and a second cleanroom for processing of the biopharmaceutical products, and a service area for supply of material for the processing of the biopharmaceutical products to the processing area, wherein at least a part of the service area adjoins the first and second cleanrooms. Further, the processing area is accessible via a processing area hallway, the service area is accessible via a service area hallway, and the processing area hallway and the service area hallway are separated from each other to preclude ingress of contaminants from the service area hallway into the processing area hallway.

According to a fifth aspect, a cleanroom facility for manufacturing of biopharmaceutical products is provided, comprising a processing area for processing of the biopharmaceutical products, a service area for supply of material for the processing of the biopharmaceutical products to the processing area, the service area being separated from the processing area by a wall, and a piece of processing equipment for processing of the biopharmaceutical products. Further, the piece of processing equipment is arranged partly in the processing area and partly in the service area, with a user interface accessible from the processing area.

According to a sixth aspect, a modular cleanroom facility for manufacturing of biopharmaceutical products is provided, the cleanroom facility being formed of a plurality of transportable modules assembled into a processing area for processing of the biopharmaceutical products and a service area for supply of material for the processing of the biopharmaceutical products to the processing area. Each of the modules comprises sidewalls, a module roof, and a module floor. Further, each of the modules is configured to be arranged in a first state in which the sidewalls, module roof, and module floor form a self-supported, transportable structure, and a second state in which at least one of the sidewalls is rearranged to form a ceiling portion of the processing area or service area of the assembled cleanroom facility.

According to a seventh aspect, an indicator system for a cleanroom facility for manufacturing of biopharmaceutical products is provided. The cleanroom facility comprises a processing area comprising a plurality of processing devices for processing of the biopharmaceutical products, and a pass-through arranged in a wall of the processing area and configured to allow material for the processing of the biopharmaceutical products to be supplied to the processing area. The indicator system comprises a pass-through indicator associated with the pass-through, a processing device indicator associated with the processing device, and a control device operatively connected to the pass-through indicator and the processing device indicator. The control device is configured to activate the pass-through indicator and the processing device based on workflow instructions governing the manufacturing of the biopharmaceutical products.

According to some embodiments, the processing area, such as the first and second cleanrooms, is configured to maintain a first grade of cleanliness, whereas the service area, such as the service room, is configured to maintain a second grade of cleanliness, the second grade being lower that the first grade.

According to some embodiments, the first and second cleanrooms are accessible from a first side, whereas the service area is accessible from a second side, opposite the first side. The cleanroom operators and the service personnel may hence enter their respective areas from opposite sides, preferably via separate hallways. Beneficially, by separating the cleanroom operators from the service personnel, the risk for persons entering the wrong room may be reduced. Further, the risk of contaminations spreading from the service area to the processing area may be reduced.

In some embodiments, the service area may comprise a first and a second service room, which may be arranged on opposite sides of a cleanroom of the processing area. In different words, a cleanroom may adjoin the first service room on one side, and the second service room on another side. Beneficially, this allows for processing equipment and material supply flows to be separated, such that the material is supplied via the first service room and the processing equipment is arranged in the second service room. The second service room, i.e., the processing equipment room, may be kept at an even lower grade of cleanliness than the first service room, as there are no passages of personnel or flow of material between the second service room and the cleanroom. Further, access to the second service room may be restricted for unauthorized personnel, such that only authorized service technicians are allowed to access the equipment. As mentioned above, the equipment may be partly arranged in the second service room and partly in the cleanroom. Preferably, the user interface parts of the equipment may be arranged in, or at least accessible from, the cleanroom whereas the remaining parts of the equipment, such as pumps, conduits, filters, and like are arranged in the second service room.

The first service room may comprise the pass-throughs as mentioned above. The first service room may hence be considered a “material-supply-only” room, whereas the second service room may be considered a “machine-service-only” room. Access to these two types of rooms may be restricted accordingly, such that material supply personnel have no access to the machine service room, while machine service personnel have no access to the material supply room.

According to some embodiments, the processing equipment may be a chromatography system, in which a user interface of the processing equipment is arranged in the processing area, or at least accessible by an operator in the processing area, and the remaining parts of the processing equipment, such as columns, filters, pumps, conduits, and the like are arranged in the service area. The invention according to the fifth aspect set out above is based on the insight that by arranging as much of the equipment as conveniently possible in the service area, the processing area space needed to accommodate the equipment may be reduced. Further, by arranging a major part of the equipment in the service area, service engineers may be able to access the equipment without having to enter the processing area. Ideally, the user interface (i.e., the parts of the equipment used for interacting with the operator) is the only part of the equipment that is arranged in the processing area.

According to an embodiment, the indicator system comprises a plurality of pass-through indicators, each of which being associated with a respective pass-through, and a plurality of processing device indicators, wherein each of the processing device indicators is associated with a respective processing device. The control device I configured to selectively activate a first one of the plurality of pass-through indicators and a first one of the plurality of processing device indicators to associate a certain pass-through to a certain processing device. The pass-through indicators and the processing device indicators may be visible indicators, such as indicator lights.

Biopharmaceutical products, also referred to as biological medical products, generally include any pharmaceutical drug manufactured from biological sources. Examples of such products include, but are not limited to, proteins.

In the context of the present disclosure, the term “processing area” generally refers to an area of the cleanroom facility comprising one or more cleanrooms.

By “cleanroom” is generally understood as a room designed, maintained, and controlled to prevent particulate and microbial contamination of the biopharmaceutical products. Preferably, such a room is assigned and reproducibly meets an appropriate air cleanliness level, of which ISO class 7 is an example.

The cleanroom area may hence form an area with defined particulate and/or microbiological cleanliness standards. This area may also be referred to as a classified area, or controlled area.

The service area, which may comprise one or more service rooms, generally refers to an area of the cleanroom facility maintained at a lower level of particulate and/or microbiological cleanliness than the cleanroom area. The service area may be used for maintenance and service of processing equipment, as well as material supply. Hence, the service area/room may also be referred to as a maintenance area/room.

By contamination is generally understood the undesired introduction of impurities of a microbiological nature or of foreign particulate matter, into or onto material, intermediate, active substance or product during production, sampling, packaging or repackaging, storage or transport with the potential to adversely impact product quality.

The terms “processing equipment” and “processing device” are used interchangeably throughout the present disclosure to refer to machinery used in the processing and manufacturing of the biopharmaceutical products. Specific examples include bioreactors, cell culture systems, separation and purification systems, such as chromatography and filtration systems, and arrangements and systems for fluid storage, fluid transfer, and fluid processing.

### BRIEF DESCRIPTION OF THE DRAWINGS

Further features and advantages of the invention will become apparent from the following description of preferred embodiments of the invention, given by way of example only, which is made with reference to the accompanying drawings. The drawings should not be considered limiting but are instead used for explaining and understanding.

FIG. 1 shows a layout of a cleanroom facility.

FIG. 2 shows a cleanroom and a service room separated by a wall.

FIGS. 3a and b show a pass-through for supply of material to the processing area.

FIGS. 3c and d show examples of a sealed container for material for biopharmaceutical processing.

FIGS. 3e and f show the use of a pass-through for supply of material to the processing area.

FIG. 4 is a perspective view of a modular cleanroom facility.

FIG. 5 is a perspective view of a module for a modular cleanroom facility, wherein the module is arranged in a first state suitable for transporting.

FIG. 6 shows the module when arranged in a second state, in which the module is being assembled into a cleanroom facility.

FIGS. 7 and 8 show a portions of an assembled modular cleanroom facility.

FIG. 9 schematically illustrates an indicator system for a cleanroom facility.

### DETAILED DESCRIPTION

Various embodiments of the inventive concept will be described more fully hereinafter with reference to the accompanying drawings, in which some, but not all embodiments and features are disclosed. It will be appreciated that the drawings are not necessarily to scale, and that the scope of the invention is defined solely by the appended claims.

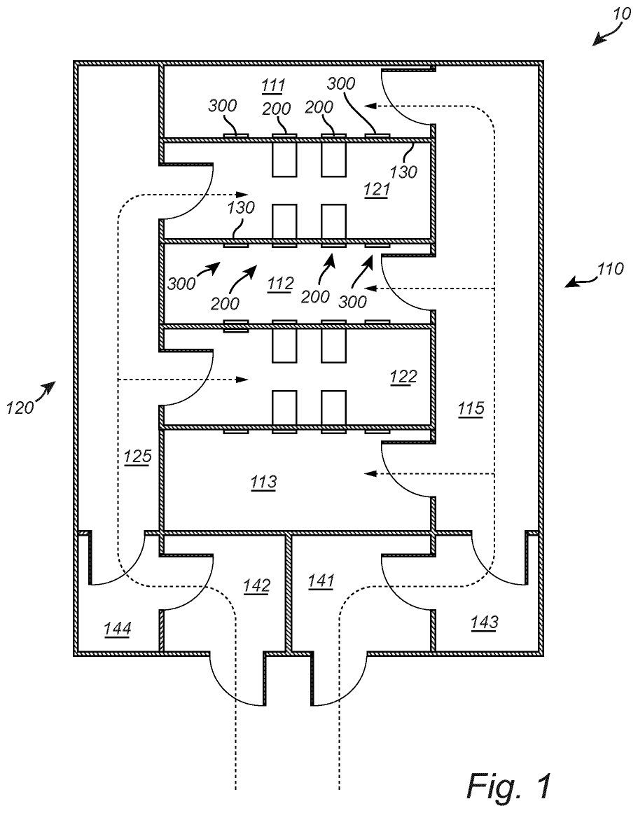

FIG. 1 is a schematic illustration of a layout of a cleanroom facility 10 for manufacturing of biopharmaceutical products. The cleanroom facility 10 comprises a processing area 110 with a first cleanroom 111 and a second cleanroom 112 for processing of the biopharmaceutical products and a service area 120 with a service room 121 for supply of material to the processing area 110. The service room 121 is provided between the first and second cleanroom 111, 112 and arranged such that it adjoins both cleanrooms 111, 112. Put differently, the service room 121 may be considered to share a wall 130 with the first and second cleanroom 111, 112, respectively. It should be noted that FIG. 1 shows an example of a layout with a one-dimensional array of rooms, wherein three cleanrooms 111, 112, 113 are interdigitated by two service rooms 121, 122. The number of rooms and particular layout may however vary between different embodiments.

The processing area 110 and the service area 120 are accessible via a respective hallway, in the present figure illustrated by the processing area hallway 115 and the service area hallway 125, through which operators and service personnel can enter their respective rooms. The processing area hallway 115 and the service area hallway 125 are separated from each other to reduce the risk of contamination in general, and more specifically to preclude ingress of contaminants from the service area hallway 125 into the processing area hallway 115. Each of the hallways 115, 125 may be formed as a corridor with rooms down one of the sides. In FIG. 1, the processing area hallway 115 extends along a first side (to the right in the figure) of the row of adjoining rooms, with entries to each of the cleanrooms 111, 112, 113, whereas the service area hallway 125 extends along a second side (to the left in the figure) of the row of adjoining rooms, with entries to each of the service rooms 121, 122. This allows for the cleanrooms 111, 112, 113 and the service rooms 121, 122 to be accessed from opposite sides.

The access to the processing area 110 and the service area 120 may be controlled by an access control system employing identification means associated to the personnel working in the areas. The identification means may be read by readers arranged at entry points of the respective areas 110, 120. The identification means may, for instance, comprise a radio frequency tag which is worn by the personnel and read upon entry request. Entry may then be authorized for persons having the correct authorization, such as service personnel entering the service area 120 and process operators entering the processing area 110. The identification means may further be employed for improved traceability and quality control.

The processing area 110 may be entered from an anteroom 141, in which the operators may don their cleanroom clothing before entering the processing area hallway 115 via an airlock 143. Similarly, the service area 120 may be entered from an anteroom 142 in which the operator can don their cleanroom clothing before entering the service area hallway 125 via another airlock 144. In the example shown in FIG. 1 the respective hallways 115, 125 are entered via separate anterooms 141, 142. Other layouts are however possible, in which the processing area hallway 115 and the service area hallway 125 are entered from a common anteroom 141, 142.

The above layout of the cleanroom facility 10 beneficially allows for the personnel to enter the processing area 110 and the service area 120 via two separate access paths, as indicated by the dashed arrows in FIG. 1. By separate paths is understood paths that are unconnected to prohibit personnel in one of the paths from entering the other one of the paths. In different words, the layout prevents service personnel in the service area 120 from accessing the processing area 110 and operators in the processing area 110 from accessing the service area 120. The service area 120 may therefore be a lesser controlled area, that is, be maintained at a lower cleanliness grade, than the processing area 110, without risking contaminating the processing area 110. Further, the layout may promote access and security control, since the number of persons accessing the respective areas 110, 120 can be reduced.

Generally, the processing area 110, or at least the cleanrooms 111, 112, 113 of the processing area 110, may be configured as clean areas with defined particle and microbiological cleanliness standards as stipulated by the relevant authorities. The processing area 110 may hence be referred to as a classified area. The service area 120, comprising service rooms 121, 122 for maintenance, service, or material supply, may have the same grade of cleanliness as the processing area 110 or be a lesser controlled area. The standards and classifications of cleanrooms are considered well known to the person skilled in the art and therefore not discussed in detail in the present disclosure.

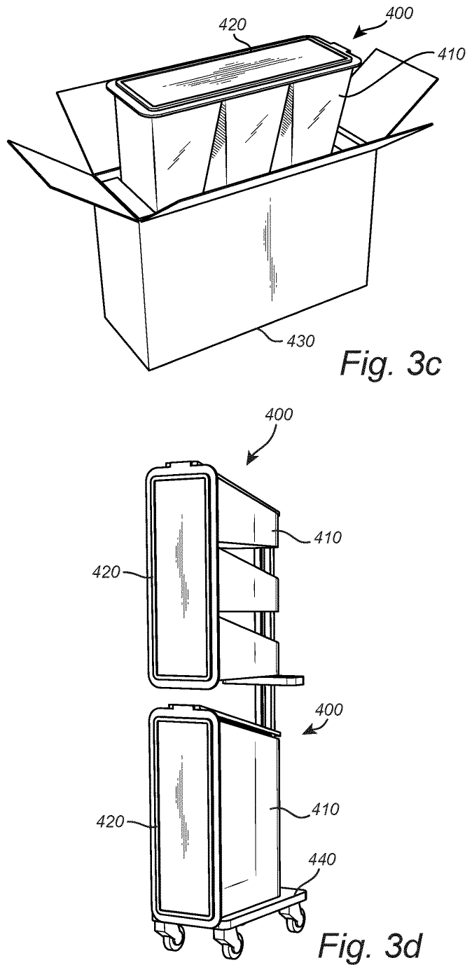

The cleanroom facility 10 of FIG. 1 may be a modular cleanroom facility 10 formed of a plurality of modules as discussed in connection with FIGS. 4-8.

The processing of the biopharmaceutical products may be performed by means of processing equipment, or processing devices 200, using raw material supplied to the cleanroom 111, 112, 113 via pass-throughs 300 in the wall 130.

While FIG. 1 shows service rooms 121, 122 with combined maintenance, service, and material supply capabilities (i.e., rooms comprising both pass-throughs 300 for material supply and processing equipment), it will be appreciated that other configurations are possible as well. In an example, the processing equipment 200 and the material supply may be separated into different service rooms. The first service room 121 may for example be dedicated for supply of material through pass-throughs 300, whereas the second service room 122 is dedicated for processing equipment 200. By dedicating the second service room 122 for processing equipment 200, the second service room 122 may be maintained at an even lower cleanliness grade than the rest of the service area 120, since there is no direct access or transfer of material to the cleanroom 112. Further, access to the respective service rooms 121, 122 may be restricted such that only authorised personnel may access the processing equipment 200.

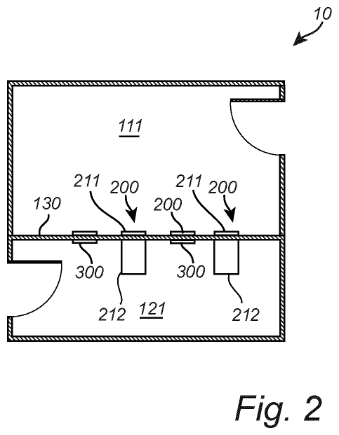

Embodiments relating to the processing equipment 200 will now be discussed with reference to FIG. 2.

FIG. 2 shows schematically a cleanroom 111 and a service room 121, which may be similarly configured as the ones shown in FIG. 1. Hence, the cleanroom 111 and the service room 121 are adjoining rooms separated by a wall 130. As illustrated in the figures, processing equipment 200 may be provided for processing of biopharmaceutical products. The processing equipment 200 is arranged partly in the processing area 110 and partly in the service area 120. Preferably, as much as possible of the housing of the processing equipment 200 may be arranged in the service area 120 to save space in the processing area 110. In the present example, a user interface of the processing equipment 200 is arranged in the cleanroom 111 while the rest of the processing equipment 200 is arranged in the service room 121. The processing equipment 200 is hence accessible to the operator via its user interface arranged in the cleanroom 111 and at the same time accessible for service and maintenance via the service room 121. By moving major portions of the processing equipment to the lesser controlled service area 120, the volume of the highly controlled processing area 110 may be reduced to save energy and costs. Processing equipment 200 may be adequately sealed at its interface towards the clean room for retaining integrity and containment of the clean room.

The wall 130 may comprise one or more openings, or pass-throughs, through which the processing equipment 200 may be introduced into the cleanroom 111. This allows for the processing equipment 200 to be installed and changed from the service side of the wall 130 to reduce contamination of the cleanroom 111. When not in use, the wall openings may be sealed by a cover which can be removed upon installation, or insertion, of a piece of processing equipment 200.

In an example, the processing equipment 200, which also may be referred to as a processing device, may be a chromatography system. A chromatography system may be understood as system providing fluid flow across a chromatographic separation unit, such as a chromatography column or a membrane adsorber, to achieve separation and purification of a drug substance. It comprises components for fluid transfer such as valves, at least one pump, and sensors for process monitoring and control. Examples of typical sensors include sensors for pressure, fluid flow, fluid conductivity, absorbance, or pH. The process is typically controlled and monitored automatically by a control system. Certain operator interactions may be required for start/stop of the system and/or entering required process and batch data.

Processing equipment may be provided as single use systems deploying single-use flow paths, wherein the latter are to be installed prior to fluid processing and removed after completion of processing. By providing clean and preferably pre-sterilized flow paths for processing of a drug substance, the need for cleaning and cleaning validation is eliminated, as well as the need for providing cleaning fluids and related installations in the first place. Single-use processing may increase process flexibility and efficiency as well as process and product safety, for example by avoiding the risk of cross-contamination when processing different drug substances and batches.

A single-use chromatography system typically consists of a re-usable instrument which allows for installation and operation of an interchangeable and disposable single-use flow path. The single-use flow path may comprise all wetted components in contact with the process fluid, such as tubing conduits, connectors, sensors, pump heads etc. Single use containers, typically comprising flexible bags, are typically connected to the flow path of the single use system for providing and receiving involved process fluids and/or fractions thereof.

An example of a typical single use chromatography system is the ÄKTA ready 450 system (made available by the applicant at the time of filing). The current system is provided as a benchtop system, however, it could be further adapted and modified to be provided and integrated into the interface of clean room and service area as described by this invention.

As indicated in FIG. 2, the wall 130 may further comprise one or more pass-throughs 300 for transferring items and material between the service area 120 and the processing area 110. The pass-throughs 300 may be arranged adjacent to a piece of processing equipment 200 and be configured to supply items and raw material to the piece of processing equipment 200, that is, ingredients intended for use in the manufacture of a product using that specific machine. A pass-through 300 may comprise interlocked doors constructed to maintain air pressure control between the adjoining rooms and preclude ingress of particulate matter and microorganism contamination from the lesser controlled service room 121. In an example, the supply of material is separated from the processing equipment 200, such that the processing equipment 200 is arranged in the first service room 121 and the material supplied from a second service room (not shown in FIG. 2).

As mentioned above, a piece of processing equipment 200 may be installed in a pass-through 300, or a remodeled pass-through. This may increase the flexibility of the cleanroom facility 10, as the pass-through 300 configuration makes it easier to add and remove processing equipment when required. By using existing pass-throughs for installing the processing equipment, no extra holes need to be made in the wall.

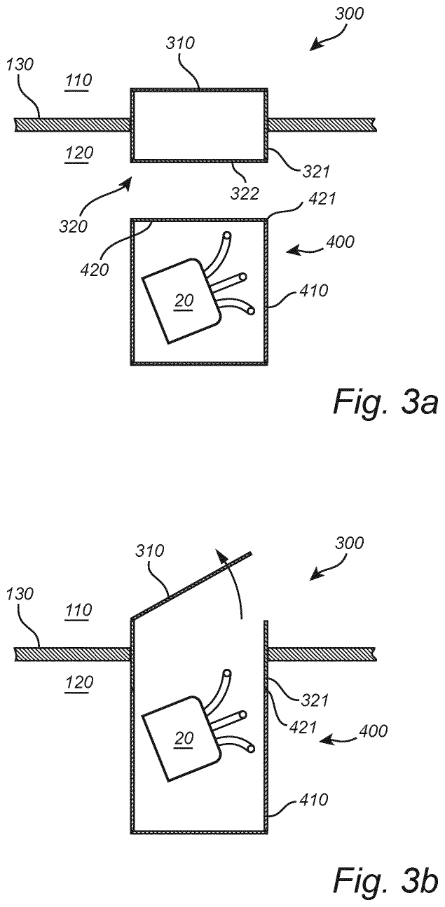

FIGS. 3a and b shows an example of such a pass-through 300, arranged in a wall 130 separating a processing area 110 and a service area 120. The processing area 110 and the service area 120 may be similarly configured as the ones discussed above with reference to FIGS. 1 and 2.

The depicted pass-through 300 is configured to allow items and raw material 20, including but not limited to bioprocessing bags and single-use assemblies (such as the ReadyCircuit 2-D and 3-D bag assemblies made available by the applicant at the time of filing), the flow path assemblies for a chromatography system (for example the flow kit for an ÄKTA ready 450 system) and/or a chromatography column to be supplied from the service area 120 to the processing area 110. Further, pre-filled fluid bags or containers providing raw material, buffers or other process fluids may be supplied to the clean room area for processing. Equally, material may be removed from the clean room area during and after processing, including samples for offline analysis outside the cleanroom area, product as the result of the processing, waste including processed fluids, used flow path assemblies etc. The pass-throughs may further be arranged to allow for parallel processing of a plurality of similar batches of drug substance, for example for personalised therapies. This may be achieved by means of a parallel line-up of multiple processing stations of the same or similar type, producing batches and of the product for individual patients. Each piece of processing equipment, or processing station, may in this configuration have an adjacent, dedicated pass-through allowing for a product and process segregation. By providing dedicated pass-throughs that are paired with the respective processing stations, there is no need to transport the material back and forth between a centralised pass-through or transfer air lock and the respective processing stations, as in the prior art. This, in turn, reduces the risk for errors and mix-ups of materials. Further, the extra footprint, required in prior art systems to accommodate for material being transported across the cleanroom from and to the central air lock, may be reduced. With the present, inventive concept, it is sufficient to move the material from and to the pass-through located adjacent to the processing station. The movement of the material may be performed manually by an operator or, in other examples, by means of robotics.

Different pass-throughs may be utilized to separate product, and sample from waste or to separate incoming from outcoming material. The material 20 is provided in a sealed container 400 which can be docked to the pass-through 300 from the service area 120 side and accessed by an operator from the processing area 110 side of the pass-through 300. The transfer of material between the processing area 110 and the service area 120 is enabled by the design of the pass-through 300, which comprises a docking port 320 facing the service area 120 and a latch 310 that is accessible from the processing area 110. The docking port comprises a docking interface 321 for receiving a corresponding docking interface of the container 400, as well as a docking door or latch 322 that seals the pass-through 300 when no container 400 is docked. The docking door 322 may be opened or removed from the pass-through either before the container 400 is docked to the pass-through 300 or after the container 400 has been docked. FIG. 3a shows the docking door 322 in a closed state, in which the door 322 is arranged to prevent contaminants from entering the pass-through 300, whereas FIG. 3b shows the docking port 320 with the docking door 322 in an opened state. Once the container 400 has been docked to the pass-through 300, an operator in the processing area 110 may open the latch 310 to access the container 400 and retrieve the material 20.

The material 20 that is to be supplied to the processing area 110 may be pre-cleaned, that is, cleaned before it is arranged in the container 400. By sealing the container 400, the cleanliness of the material 20 may be preserved during storage, transport, and handling to reduce the need for additional cleaning of the material 20 before it is brought into the processing area 110. The material 20 for the processing of the biopharmaceutical products may hence be provided to the processing area 110 by service personnel docking the container 400 to the pass-through to make the material 20 accessible to an operator operating the processing equipment in the processing area 120.

The cleanroom facility 20 may be used for a so-called closed system processing, in which a sterile product is not exposed to the surrounding environment. This can be achieved by the use of bulk product holders, such as tanks or bags, that are connected to each other as a system, with the system being sterilised after the connections are made. By providing pre-cleaned material 20 in the sealed containers 400, the closed system may be extended outside the cleanroom facility 20. Put differently, by cleaning and sealing the material in the containers off-site, the clean environment may be extended beyond the cleanroom facility 20.

The container 400 comprises a body 410 configured to accommodate the material 20, a sealing 420 for maintaining a predetermined grade of cleanliness of the material 20 during storage and handling, and a docking interface 421 for docking the container 400 to the docking port 320 of the pass-through 300. The body 410 may for example form a box having a size and shape adapted to accommodate the desired material, such as single-use bags of various sizes. The docking interface 421 of the container 400 may be arranged at an opening or rim of the body 410 and comprise structures adapted to engage with corresponding structures on the docking interface 321 of the pass-through. Examples of such structures include mutually engaging threads and snap-lock interconnections.

The container sealing 420 may be formed of a lid or a single use sealing that can be opened or punctured by the operator from the processing area side of the wall 130. In an example, the sealing 420 comprises a plastic film that is hermetically sealed to the rim of the container body 410 and removable after the container 400 has been docket to the pass-through.

Container 400 may be sealed off prior to detachment and removal from the pass-through. Hereby, material removed from the clean room may be transported under closed, contained and controlled conditions to a different location for further processing. This may involve connecting of the container to another clean room. If the material is to be disposed, the container may ensure safety for operators and environment during transport, and/or the container may be disposed together with its content.

The pass-through 300 may comprise a cleaning system for removing contaminants in the pass-through 300 before the latch 310 is opened. The cleaning system may for example be an air replacement system, or air flushing system, changing the air in the pass-through 300 after the container 400 has been docked. In another embodiment, the cleaning system may further comprise bioburden reduction systems, such as ultraviolet light treatment arrangements or automated fogging systems.

As illustrated in FIGS. 1 and 2, the pass-through may be located adjacent to the processing equipment to which the material is to be supplied. This reduces transport of the material in the cleanroom 111 and the risk of the material being supplied to the wrong processing equipment. Further, by enabling pre-cleaned material to be supplied to the cleanroom 111, the operator does not have to spend time on additional cleaning of the material.

The access to the pass-throughs may be controlled such that only authorized, or adequately trained personnel is allowed to open the latch 310 to retrieve the material. In some examples, the access may be restricted to an identify of an operator or an identification means carried by the operator. The identification means may, for instance, comprise a radio frequency tag which is worn by the operator and read by a reader operatively coupled to the pass-through. Example of possible identification means include active and passive RFID tags, which, for instance, may be integrated in a wearable item such as an armband. To open the pass-through, the operator may scan the tag at a reader associated with the pass-through. This allows for the access to the pass-through to be restricted to authorized personnel and for the traceability and quality assurance to be improved.

FIG. 3c illustrates a container 400 according to an embodiment, having a body 410 and a sealing 420 defining a clean environment which is compatible with the cleanliness standard in the processing area. The container 400 may be provided in transport packing 430, such as a cardboard box, from which the container 400 may be removed before it is docked to the pass-through 300. The container 400 according to the present example is a transparent polypropylene plastic box with a lid 420 that is snap-locked onto the box.

The container 400 may be handled and transported in the service area by means of a trolley, or cart 440. FIG. 3d shows an example of a cart 440 configured to carry two containers 400, of which the first one comprises a single compartment and the second one comprises three compartments. It will be appreciated that the body 410 of the container 400 may have a shape and number of compartments that vary with the different types of material handled, and that the illustrated containers 400 are non-limiting examples.

The cart 440 is configured to orient the containers 400 with the sealing 420 facing forward to facilitate the docking to the pass-through.

In FIG. 3e the containers 400 have been docked to the pass-throughs 300 and the sealing 420 removed to enable access to the material from the cleanroom 111. FIG. 4f shows the pass-through 300 from the cleanroom-side, wherein the latch 310 has been opened by the operator to allow the material stored in the compartment(s) of the container 400 to be retrieved and carried to the processing equipment.

The above-described cleanroom facility 10 may be formed of a plurality of modules, as illustrated in the example of FIG. 4. FIG. 4 shows a facility 10 formed of a plurality of transportable modules 500 that are assembled into a processing area and a service area similar to the ones discussed above in connection with FIGS. 1, 2 and 3a-b. The cleanroom facility 10 may hence be referred to as modular cleanroom facility 10. The modular configuration makes it possible to change the layout, size or shape of the facility to meet changing requirements and allow the cleanroom to be relocated. A more flexible cleanroom facility is hence provided, which is easier to scale to optimised capacity.

The modules 500 may be prefabricated, freestanding structures that are fitted with a self-contained heating, ventilation, and air conditioning (HVAC) as well as an electrical system. The modules 500 may have a shape and size corresponding to traditional intermodal shipping containers to allow easy and efficient transporting. The modules may be transported by for example road or rail to locations where there is a need for new or additional production capacity. In this example, the module 500 is dimensioned as a 20 ft high cube (HC) container complying with the global containerised intermodal freight transport system.

A modular configuration of the cleanroom facility beneficially allows for the facility to be extended to meet an increased market demand, as well as decommissioned, relocated and then recommissioned, if needed. The modular configuration may hence be considered a flexible choice to accommodate future demands.

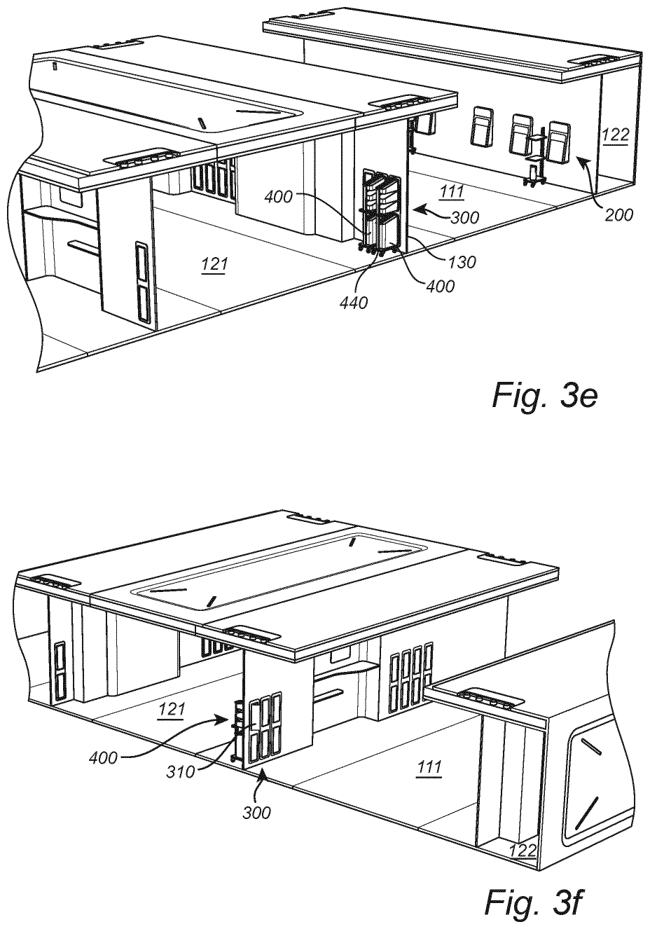

FIG. 5 is a perspective view of a module 500 according to an embodiment, which may be similarly configured as the modules 500 shown in FIG. 4. The module 500 comprises sidewalls 510, a module roof 520, and a module floor (not shown in the present figure). In the present figure, the sidewalls 510, module roof 520, and module floor are arranged in a first state to form a self-supported, transportable structure. The module 500 further comprises an interconnection structure 540, in the present example arranged at the module roof 520, for connecting infrastructural systems such as HVAC and electrical systems to neighbouring modules 500 of the assembled cleanroom facility 10.

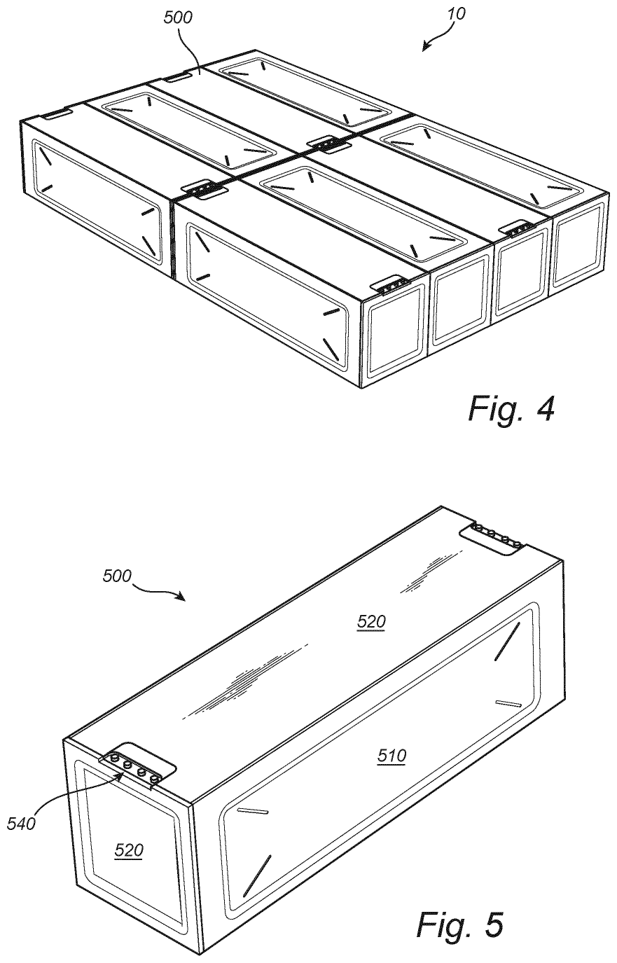

FIG. 6 shows the module 500 in a second state, in which at least some of the sidewalls 510 have been rearranged to form a ceiling portion or floor portion of the processing area 110 or the service area 120 of the assembled cleanroom facility 10. The sidewalls 510 of the transportable module 500 may thus be provided with the necessary infrastructure, such as HVAC and electrical installations, prior to delivery to site, to reduce construction time on site.

In the present figure, the sidewalls 510 have been moved from their vertical position in the first state shown in FIG. 5 into the horizontal position shown in FIG. 6. The sidewalls 510 may therefore be considered to have double functions: a first function in which they protect the pre-installed processing machinery during transport, and a second function as ceiling or floor of the assembled cleanroom facility 10. The double function of the sidewalls 510 beneficially reduces the need for additional transport packaging.

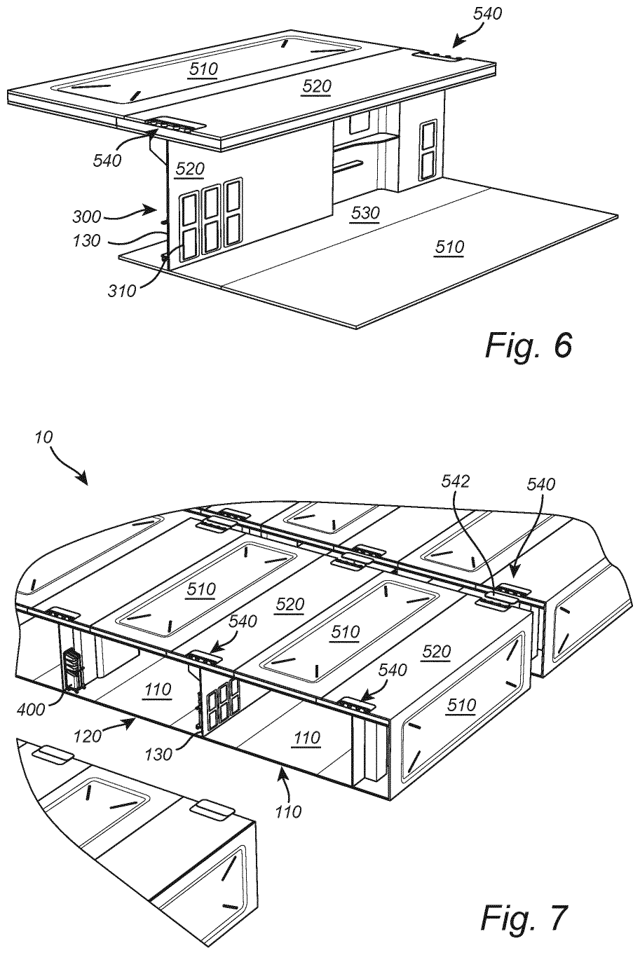

In FIG. 7 a plurality of modules 500, similar to the one shown in FIGS. 5 and 6, have been assembled into a cleanroom facility 10 comprising a processing area 110 and a service area 120 as discussed above in connection with, for instance, FIGS. 1 and 2. Each of the modules 500 has been arranged in the second state, in which at least some of the sidewalls 510 have been rearranged into a horizontal position to form portions of the floor and ceiling of the processing and service areas 110, 120 of the assembled cleanroom facility 10. The ceiling-forming sidewall 510 of a first one of the modules 500 is connected to a module roof 520 of a second, neighbouring one of the modules 500 to form a continuous ceiling structure of the assembled cleanroom facility 10. Similarly, the floor-forming sidewall 510 of said first one of the modules 500 is connected to a module floor 530 of said second, neighbouring one of the modules 500 to form a continuous floor of the assembled cleanroom facility 10. Further, the modules 500 are interconnected via their respective interconnection structure 540, in which the interconnection points 541 are structurally and functionally connected to each other via a bridging member 542. In the present example, the interconnection points 541 of each module 500 are accessible from above, from the outside of the module 500, allowing the bridging member 542 to be fitted with the interconnection points 541 from the outside of the cleanroom facility 10.

When assembled, the modular cleanroom facility 10 comprises a processing area 110 with a plurality of cleanrooms and a service area 120 with a plurality of service rooms for supply of material to the processing area 110. In the layout shown in FIG. 7, the cleanrooms are separated from each other by a service room, in which at least some parts of the processing equipment are arranged to reduce the volume of the cleanrooms. The cleanrooms may hence be considered to form a one-dimensional array of cleanrooms, which is interdigitated by service rooms. The service rooms and the cleanrooms are separated from each other by a wall 130, in which a plurality of pass-throughs 300 may be arranged to allow items and material to be supplied to the cleanroom. The pass-throughs 300 may be similarly configured as the embodiments disclosed above in connection with FIGS. 3a and b. FIG. 7 shows a cleanroom wherein the separating wall 130 comprises a plurality of pass-through latches 310 that can be opened by the operator to assess the material that is to be supplied to the cleanroom. On the opposite wall 130 of the service room, a trolley comprising a plurality of containers 400 is disclosed, which are docked to corresponding pass-throughs 300 to a neighbouring cleanroom. The trolley, or cart, may hence be configured to carry one or more containers 300 to facilitate transport within the service area 120 as well as docking to the pass-throughs 300. The containers 400 may be similarly configured as the embodiments disclosed in FIGS. 3a and b and may hence be sealed to maintain a clean environment in which pre-cleaned material, such as single-use bags for the processing of biopharmaceutical products, is accommodated.

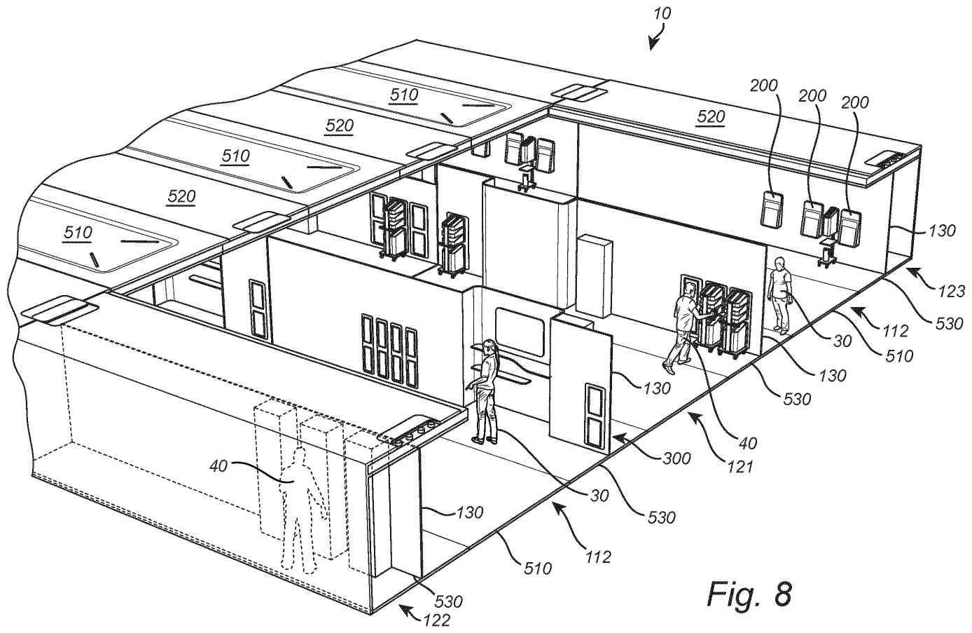

FIG. 8 is a further example of an assembled cleanroom facility 10, which may be similarly configured as the one shown in, for example, FIGS. 1 and 7. FIG. 8 shows an array of adjoining rooms, wherein a first cleanroom 111 and a second cleanroom 112 of the processing area 110 are separated by a first service room 121 of the service area 120. Each of the cleanrooms 111, 112 also adjoins a second and a third service room 122, 123, respectively, arranged at the side opposing the first service room 121. In the present example, the first service room 121 forms a supply area for supply of material to the cleanrooms 111, 112, whereas the second and third service rooms 122, 123 forms a respective maintenance area for maintenance of the processing equipment and other service and maintenance tasks associated with the operation of the cleanroom facility 10. The cleanroom facility 10 may comprise hallway areas (not shown) that are separate for the processing area 110 and the service area 120, such that personnel operating in the cleanrooms 111, 112 is prevented from accessing the service area 120 and vice versa. FIG. 8 indicates presence of two different personnel categories with difference access authorization: operators 30 handling the processing equipment 200 on the processing area 110, and service or maintenance personnel 40 performing maintenance on the processing equipment 200 and supplying material to the processing area 110. In the present example, the operators 30 may be authorized to access the processing area 110 but not the service area 120, whereas the service or maintenance personnel 40 may be authorized to access the service area 120 but not the processing area 120. By arranging the entrances to the respective areas in separate hallways (not shown), the risk for unauthorized access and inter-contamination among the processing and service areas may be reduced.

During operation, material may be supplied to the supply area 121 in sealed containers 400 carried by a trolley. The trolley may be used by a person 40 working in the service area 120 to transport the sealed container 300 to a pass-through 300 arranged in the wall 130 adjoining the cleanroom 111, 112, at which the container 300 is docked and the sealing removed. On the other side of the wall 130, in the adjoining cleanroom 111, 112, an operator 30 may open a latch in the pass-through to access the material in the container 400 and bring the material to the user interface of the relevant processing equipment 200. The operator 30 may be assisted by visual indicators associating a pass-through 300 with a particular piece of equipment 200, or vice versa.

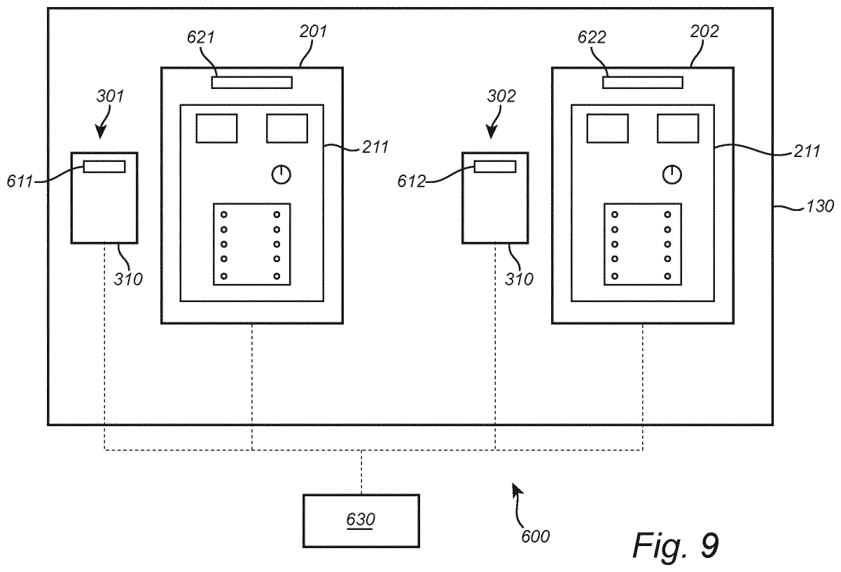

FIG. 9 is a schematic illustration of an indicator system 600 for aiding the operator in the processing of the biopharmaceutical products and the handling of material supplied to the processing equipment 200. The indicator system 600 comprises a plurality of indicators 611, 612, 621, 622 that can be individually activated to guide the personnel operating in the processing area. The indicators may, for instance, be visual indicators, such as indicator lights or light towers. The indicators may operate on a digital basis, that is, either be switched ON of OFF, to convey information to the operator. Alternatively, the indicators may convey information by assuming different colours, such as green, yellow, or red, and/or by blinking in a predetermined pattern. For the purpose of the present disclosure, an indicator is considered to be arranged in an active state, or activated, to convey information to the operator in any of the above-mentioned options. An indicator may thus be activated to indicate to the operator which of the processing devices that is to be used, or from which of the pass-throughs material should be retrieved. Each of the processing devices may hence be associated with a respective indicator, which either may be integrated in the user interface of the processing device or arranged at, or adjacent, the processing device. Similarly, each of the pass-throughs may be associated with a respective indicator, which may be integrated in the latch of the pass-through or arranged adjacent the pass-through.

FIG. 9 shows an exemplary embodiment of such an indicator system 600 provided in a processing area comprising a plurality of processing devices 201, 202 (also referred to as processing equipment) and plurality of pass-throughs 301, 302 arranged in a wall 130 separating the processing area from an adjoining service area. The processing area and the service area may form part of a cleanroom facility that is similarly configured as the cleanroom facilities discussed above in connection with, for example, FIGS. 1 and 2. In the present example, the processing area comprises a first processing device 201 and a second processing device 202, each having a respective user interface 211 through which the operator may supply raw material retrieved from the pass-throughs 301, 302. The processing devices 201, 202 further comprises a respective indicator, or a processing device indicator, which in this example comprises indicator lights 621, 622 that can be individually controlled. The processing area further comprises a first pass-through 301 and a second pass-through 302, each having a respective latch 310 through which the operator can access the raw material that is supplied from the adjoining service area. Each of the pass-throughs 301, 302 comprises a respective indicator, such as an indicator light 611, 612, which may be individually controlled similarly to the processing device indicators 621, 622.

The indicator system 600 further comprises a control device 630 configured to control the operation of the indicators 611, 612, 621, 622. The control device 630 may, for example, be configured to associate one of the pass-throughs 301, 302 to one of the processing devices 201, 202 by activating their respective indicator 611, 612, 621, 622. The control device 630 may hence activate the first pass-through indicator 611 and the second processing device indicator 622 (in this case by turning on the light, or by generating a blinking light), to indicate to the operator to retrieve material from the first pass-through 301 and use the material in the second processing device 302.

The control device 630 may operate on instructions provided from a predetermined process workflow, comprising a sequence of instructions on how to operate the processing devices to generate the desired biopharmaceutical products. The control device 630 may, in some examples, be configured to operate the indicators in response to a query or trigger provided by the operator. The operator may for example ask for instructions related to a specific step in the process workflow, whereupon the indicator system 600 may respond by indicating which processing device 201, 202 and pass-through 301, 302 to use.

In some examples, the control device may operate based on input from an identification means reader. The reader may be configured to read an identification means worn by an operator, as outlined above. The operator may use the identification means to active or retrieve information about a next step in the process workflow, and to enquire from which pass-through to retrieve the material and to which processing device to bring the material.

The identification means may also assist in generating a digital batch protocol. The operator may allow the identification means to be read when initialising a new step in the workflow, or when finishing a step in the workflow.

The control device 630 may be configured maintain a digital inventory of which type of raw material is accessible through which pass-through. Put differently, the pass-throughs may be pre-loaded with raw material that is stored at the pass-throughs until it is needed. The plurality of pass-throughs may hence be used for storing a supply of material. By keeping track of in which pass-through to find which type of material, the control device 630 can guide the operator from where to retrieve the material when needed. In this configuration, the pass-throughs 301, 302 and the indicator system 600 can be used as a push-type buffer inventory in which the material in store is replaced once it has been consumed. It is however possible to use the pass-throughs 301, 302 and the indicator system 600 as a pull-type inventory, in which the material is supplied to a pass-through upon demand, i.e., when the material is needed in the processing.

It will be appreciated that a similar use of indicators may be employed at the service area side of the pass-throughs for guiding service area personnel providing the material to the pass-throughs. Hence, an indicator associated with a certain pass-through may be activated to indicate to the service area personnel where to insert the material.

The above embodiments are to be understood as illustrative examples of the inventive concept. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A cleanroom facility (10) for manufacturing of biopharmaceutical products, comprising: a processing area (110) for processing of the biopharmaceutical products; a service area (120) for supply of material (20) for the processing of the biopharmaceutical products to the processing area, the service area being separated from the processing area by a wall (130); a pass-through (300) arranged in the wall, the pass-through being configured to allow the material to be supplied to the processing area; wherein the pass-through comprises a latch (310) facing the processing area (110) and a docking port (320) facing the service area (120); and wherein the docking port is configured to allow a sealed container (400), comprising the material, to be docked to the pass-through and accessed through the latch.

2. (canceled)

3. (canceled)

4. A cleanroom facility (10) for manufacturing of biopharmaceutical products, comprising: a processing area (110) comprising a first and a second cleanroom (111, 112) for processing of the biopharmaceutical products; and a service area (120) comprising a service room (121) for supply of material (20) for the processing of the biopharmaceutical products to the processing area, the service room adjoining the first and second cleanrooms; wherein: the processing area is accessible via a processing area hallway (115); the service area is accessible via a service area hallway (125); and the processing area hallway and the service area hallway are separated from each other to preclude ingress of contaminants from the service area hallway into the processing area hallway.

5. The cleanroom facility (10) according to claim 4, wherein the first and second cleanroom are configured to maintain a first grade of cleanliness, and wherein the service room is configured to maintain a second grade of cleanliness, the second grade being lower than the first grade.

6. The cleanroom facility (10) according to claim 4, wherein the first and second cleanrooms are accessible from a first side, and wherein the service room is accessible from a second side, opposite the first side.

7. A cleanroom facility (10) for manufacturing of biopharmaceutical products, comprising: a processing area (110) for processing of the biopharmaceutical products; a service area (120) for supply of material (20) for the processing of the biopharmaceutical products to the processing area, the service area being separated from the processing area by a wall (130); and a piece of processing equipment (210) for processing of the biopharmaceutical products; wherein the piece of processing equipment is arranged partly in the processing area and partly in the service area, with a user interface (211) accessible from the processing area.

8. The cleanroom facility (10) according to claim 7, wherein: the service area comprises a first service room (121) and a second service room (122), the first service room and the second service room being arranged on opposite sides of a cleanroom (111, 112) of the processing area; the first service room is arranged for the supply of the material (20); and the piece of processing equipment is arranged partly in the second service room.

9. The cleanroom facility (10) according to claim 7, wherein the piece of equipment is a chromatography system.

10. The cleanroom facility (10) according to claim 9, wherein a user interface (211) of the chromatography system is arranged in the processing area and the remaining parts of the chromatography system (212) are arranged in the service area.

11-15. (canceled)
